(19) United States
(12) Patent Application Publication
(10) Pub. No.: US 2013/0200798 A1
(43) Pub. Date: Aug. 8, 2013

(54) Fluorescent Lamp Dimmer

(71) Applicants: Laurence P. Sadwick, Salt Lake City, UT (US); William B. Sackett, Salt Lake City, UT (US)

(72) Inventors: Laurence P. Sadwick, Salt Lake City, UT (US); William B. Sackett, Salt Lake City, UT (US)

(21) Appl. No.: 13/760,911

(22) Filed: Feb. 6, 2013

Related U.S. Application Data
(60) Provisional application No. 61/595,927, filed on Feb. 7, 2012.

(51) Int. Cl. H05B 41/36

(52) U.S. Cl. CPC H05B 41/36
USPC 315/114

(57) ABSTRACT

A fluorescent lamp dimmer is disclosed herein, which may dimmably power one or more fluorescent lamps. The fluorescent lamp dimmer includes a fluorescent lamp power output, at least one fluorescent lamp heater output, a dimmable current source operable to yield a controllable constant current, a current-fed inverter operable to power the fluorescent lamp output from the controllable constant current, and a heater circuit operable to power the at least one fluorescent lamp heater output. The heater circuit provides power at a substantially constant level while the controllable constant current is variable.

### CROSS REFERENCE TO RELATED APPLICATIONS

The present application claims priority to U.S. Patent Application No. 61/595,927 entitled “Fluorescent Lamp Dimmer”, filed Feb. 7, 2012, the entirety of which is incorporated herein by reference for all purposes.

### BACKGROUND

Fluorescent lamps are widely used in a variety of applications, such as for general purpose lighting in commercial and residential locations, in backlights for liquid crystal displays in computers and televisions, etc. Fluorescent lamps generally include a glass tube, circle, spiral or other shaped bulb containing a gas or mixture of gasses at a relatively low pressure, such as argon, xenon, neon, or krypton, along with low pressure mercury vapor during operation. A fluorescent coating is deposited on the inside of the lamp. As an electrical current is passed through the lamp, mercury atoms are excited and photons are released, most having frequencies in the ultraviolet spectrum. These photons are absorbed by the fluorescent coating, causing it to emit light at visible frequencies. Some types of fluorescent lamps include heaters in the tubes which are heated by an electrical current, providing a source of electrons in the tubes. Many power supplies for fluorescent lamps, including ballasts, cannot be used with conventional AC wall dimmers such as TRIACs and SCRs.

### SUMMARY

The present invention provides a fluorescent lamp dimmer that can be used to power one or more fluorescent lamps and that is dimmable with conventional AC wall dimmers as well as with internal dimming circuits. In some embodiments, the fluorescent lamp dimmer includes a fluorescent lamp power output, at least one fluorescent lamp heater output, a dimmable current source operable to yield a controllable constant current, a current-fed inverter operable to power the fluorescent lamp output from the controllable constant current, and a heater circuit operable to power the at least one fluorescent lamp heater output. The heater circuit provides power at a substantially constant level while the controllable constant current is variable.

This summary provides only a general outline of some particular embodiments. Many other objects, features, advantages and other embodiments will become more fully apparent from the following detailed description. Nothing in this document should be viewed as or considered to be limiting in any way or form.

### BRIEF DESCRIPTION OF THE DRAWINGS

A further understanding of the various exemplary embodiments may be realized by reference to the figures which are described in remaining portions of the specification. In the figures, like reference numerals may be used throughout several drawings to refer to similar components.

FIG. 1 depicts a fluorescent lamp dimmer suitable for dimmably powering one or more fluorescent lamps in accordance with various embodiments of the invention.

FIG. 2 depicts a fluorescent lamp dimmer including an AC wall dimmer in accordance with various embodiments of the invention.

FIGS. 3-5 depict fluorescent lamp dimmers including a number of power factor control devices in accordance with various embodiments of the invention.

FIG. 6 depicts a fluorescent lamp dimmer connected to two fluorescent lamps in parallel in accordance with various embodiments of the invention.

FIG. 7 depicts a fluorescent lamp dimmer connected to two fluorescent lamps in series in accordance with various embodiments of the invention.

FIG. 8 depicts an example of a current fed inverter suitable for use in some embodiments of a fluorescent lamp dimmer in accordance with various embodiments of the invention.

FIG. 9 depicts an example circuit that may be used in place of a dimmable current source and/or a heater source circuit of FIG. 1 in accordance with various embodiments of the invention.

FIG. 10 depicts a plot of example output current versus input voltage settings in a dimmable current source in accordance with some embodiments.

FIG. 11 depicts a plot of example output current versus input voltage settings in a heater source circuit in accordance with some embodiments.

### DESCRIPTION

Brief definitions of terms used throughout this document are given below. The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phrases do not necessarily refer to the same embodiment.

If the specification states a component or feature “may”, “can”, “could”, or “might” be included or have a characteristic, that particular component or feature is not required to be included or have the characteristic.

A fluorescent lamp dimmer is disclosed herein that may be used to power one or more fluorescent lamps, and that may be dimmed if desired either with various types of external dimmers or with internal dimming circuits. The fluorescent lamp dimmer enables control of the voltage and current across the fluorescent lamps in order to control the luminosity or intensity, while maintaining a substantially constant voltage through the heaters. Thus, the input voltage may be controlled and limited either externally or internally to dim the fluorescent lamps, while maintaining the heater voltage for proper lighting of the lamps. It is important to note that the term “fluorescent lamp dimmer” refers in some embodiments to a power supply or driver circuit that does not itself include a dimmer or dimming control input, but that is adapted to operate properly with an external dimmer and to allow the luminosity of the fluorescent lamps to be controlled with the external dimmer. In other embodiments, the fluorescent lamp dimmer may include internal dimming circuits and/or dimming control inputs. Yet other embodiments may operate with a combination of internal and external dimmers.

The present invention thus describes a means of controlling the dimming of fluorescent lamps which can include tube fluorescent lamps (Fls) of all types and shapes including linear, bent, u-shaped, etc., compact fluorescent lamps (CFLs), energy efficient lamps, cold cathode fluorescent lamps (CCFLs), etc.

Some embodiments include the use of a dimming to constant current transfer function that permits the dimming level to be translated into a constant current that is proportional to the dimming level. Notably, proportionality can be but does not necessarily need to be linear and almost any function can be used and/or can be designed/programmed into the present invention including, but not limited to, quadratic, offset, sub-linear,super-linear, cubic, power law or power series, logarithmic, etc. The present invention takes the constant current provided by the dimming to constant current transfer function and applies this current to a circuit such as a current fed inverter, including current fed inverters based on resonant current fed inverter designs, and converts the output to an appropriate waveform to drive the fluorescent lamps. In addition, a constant output heater/filament/cathode circuit is included that permits the voltage, current and power to remain substantially constant across the heaters/filaments/cathodes during operation, including while dimming. A feature of the present invention is the ability to tailor and custom design the performance, transfer curves (including the Input Voltage vs. Output heater/filament/cathode voltage) to obtain the desired performance, characteristics, transfer characteristics, etc.

The present invention can be used with alternating (AC) 50 or 60 Hz line voltage, direct current (DC) input voltage, 400 Hz, and most any other type of waveform and frequency including multiple frequencies. The present invention can be dimmed using any conventional method and way including TRIAC dimmers, thyristor dimmers, silicon controlled rectifier (SCR) dimmers, transistor dimmers, capacitive dimmers, variacs, DC dimmers, phase dimmers, forward and reverse dimmers, etc. The present invention can be used with all types of low voltage dimming signals including DALI, 0 to 10 V dimming, RS 232, USB, Ethernet, I2C, SPI, SPC, etc., any other type of wired dimming including powerline wire dimming, wireless dimming including bluetooth, Zigbee, WiFi, IEEE 802 standards, 25 MHz, 49 MHz, any allowable MHz and GHz wireless frequencies, infrared (IR) transmissions, and essentially any wired or wireless approach. The present invention can be designed and implemented to respond to, for example, both wall (i.e., triac) dimming and remote (i.e., wired or wireless) dimming.

Certain embodiments of the present invention may also use current limiting, either in the input or output circuitry to limit the maximum current through the lamps. An example of this, which is not intended to be limiting in any way or form for the present invention, is to current limit the maximum constant current that the dimming to constant current transfer function can provide. By doing so, this would thus limit the amount of power and current to the lamps. Other embodiments could sense the current in the output circuit and provide feedback to the dimming to constant current transfer function. Still other embodiments could incorporate a combination of the these and/or also limit the AC input current. Any combination (i.e., one or more) of wall, wired, wireless, etc. dimming may be incorporated into the individual and respective implementations and embodiments of the present invention. Again, nothing here is to be taken as limiting in any way or form for the present invention.

The dimming to constant current transfer function can be realized using a number of circuit topologies including isolated and non isolated approaches and topologies, buck, boost, buck-boost, boost-buck, Cuk, flyback, etc. and can be realized using discontinuous conduction mode (DCM), continuous conduction mode (CCM), critical conduction mode, resonant conduction, etc. Examples of such a dimming to constant current transfer function circuit include any of the circuits in U.S. patent application Ser. No. 12/776,435 for a “Universal Dimmer”, filed May 10, 2010, which is incorporated herein by reference.

The present invention can also be designed, configured, and implemented to have high power factor and have either passive or active power factor correction (PFC).

The present invention can also be designed with integrated circuits (ICs) specifically designed and implemented for the present invention. These ICs can reduce the number of components, combine functionality, allow one IC to control more than one function or operation, reduce the size and cost of the present invention, combine blocks, provide common global and local functions, etc.

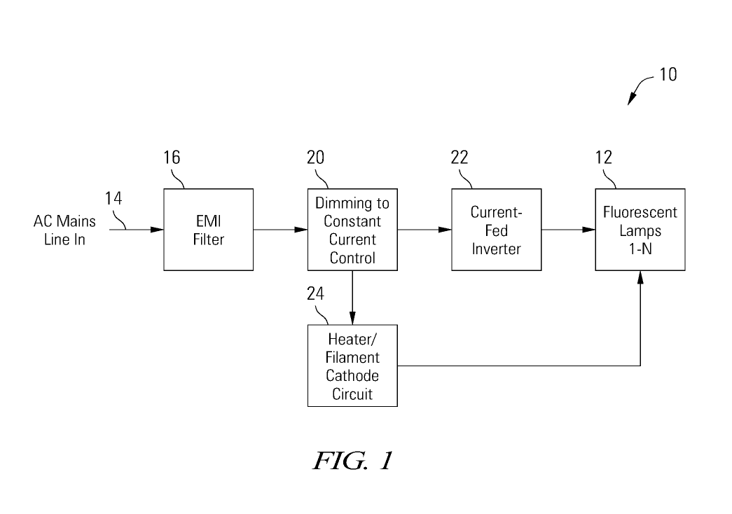

Turning now to FIG. 1, an example of a fluorescent lamp dimmer 10 is illustrated, in which one or more fluorescent lamps 12 are powered from AC mains input 14 or from any other suitable power input, such as DC or other input waveforms. The input may be filtered in an EMI filter 16 to reduce EMI as needed. A dimming to constant current control circuit 20, also referred to herein as a dimmable current source, is operable to generate a constant but controllable current for a current fed inverter 22 based on the AC mains in 14 or other power input. A heater/filament cathode circuit 24, also referred to herein as a heater source, is operable to provide a substantially constant low current or voltage for the fluorescent lamps 12 or other load, even when the input voltage is lowered by an external dimmer.

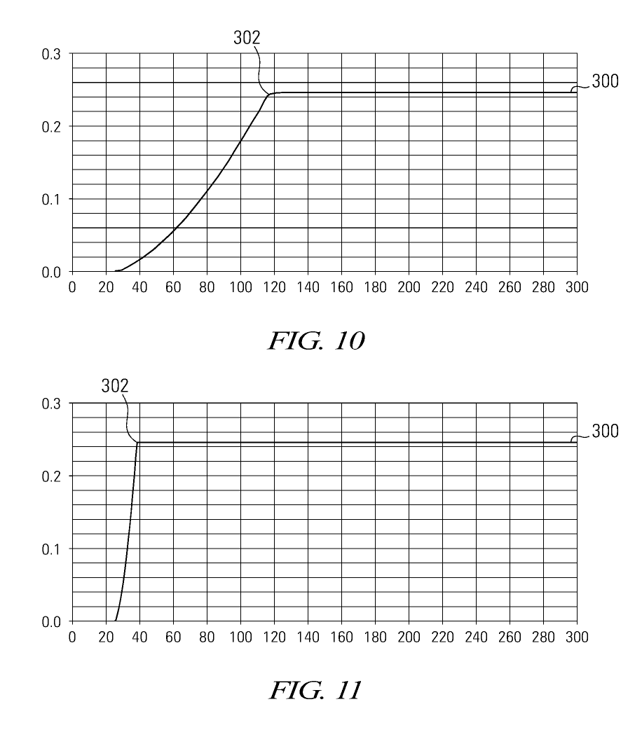

For example, the circuits disclosed in the “Universal Dimmer” document may be used for each of the dimming to constant current control circuit 20 and heater/filament cathode circuit 24, with the circuits adjusted such that the current vs voltage plots (e.g., FIG. 10) have the current slope beginning at about 30 VAC (or any other desired starting voltage including lower than 30 VAC) and increasing across the input voltage range as provided by a dimmer for use as the dimming to constant current control circuit 20, and having the knee 302 lowered to provide a substantially constant current across the entire dimming range for use as the heater/filament cathode circuit 24 (see, e.g., FIG. 11). Thus, for the dimming to constant current control circuit 20, the output current provided to the current fed inverter 22 will be proportional to the input voltage from the AC mains Line In 14, which may be adjusted in some embodiments by an external dimmer. For the output of the heater/filament cathode circuit 24, the output current and/or voltage will remain substantially constant independent of the input voltage level from the AC mains Line In 14, which again may be adjusted in some embodiments by an external dimmer.

The current and/or voltage levels provided by the dimming to constant current control circuit 20 and the heater/filament cathode circuit 24 may be adapted to the intended load, for example to the number of fluorescent lamps, their voltage rating and the topology in which they are connected. For example, given four 100V fluorescent lamps connected in series as load 12, the output voltage from dimming to constant current control circuit 20 may be set at about 400V when not being dimmed and may decrease from that point when being dimmed. The current and/or voltage levels provided by the heater/filament cathode circuit 24 are similarly set based on the requirements of the fluorescent lamps 12, for example providing a constant 5V to the heaters of the fluorescent lamps 12, or whatever voltage and/or current is required by fluorescent lamps 12 based on their breakdown voltage, etc. The heater/filament cathode circuit 24 is adapted to very rapidly reach the required heater voltage even at small dimming angles by adjusting the supply circuit in heater/filament cathode circuit 24, for example setting the knee 302 (FIG. 11) at a low input voltage that results from the small dimming angles. Certain embodiments of the present invention may use a heater circuit that decreases or even turns off the output voltage, current and power as the dimming level approaches the fully on condition.

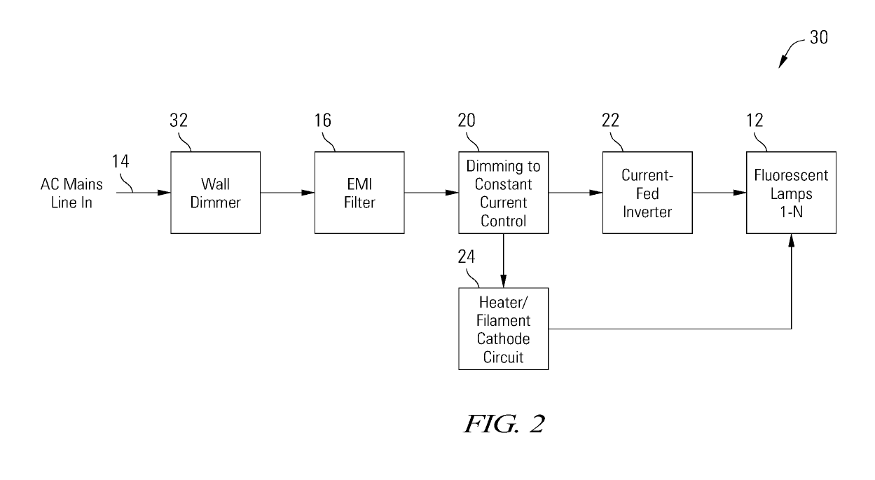

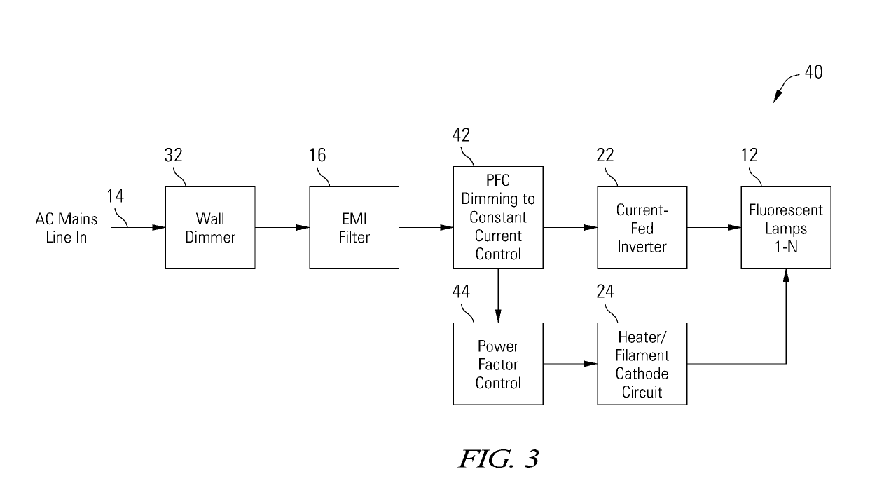

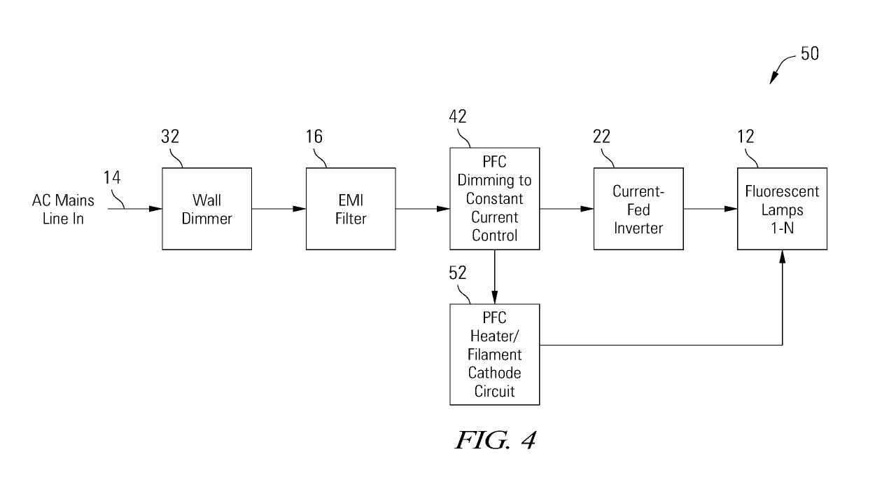

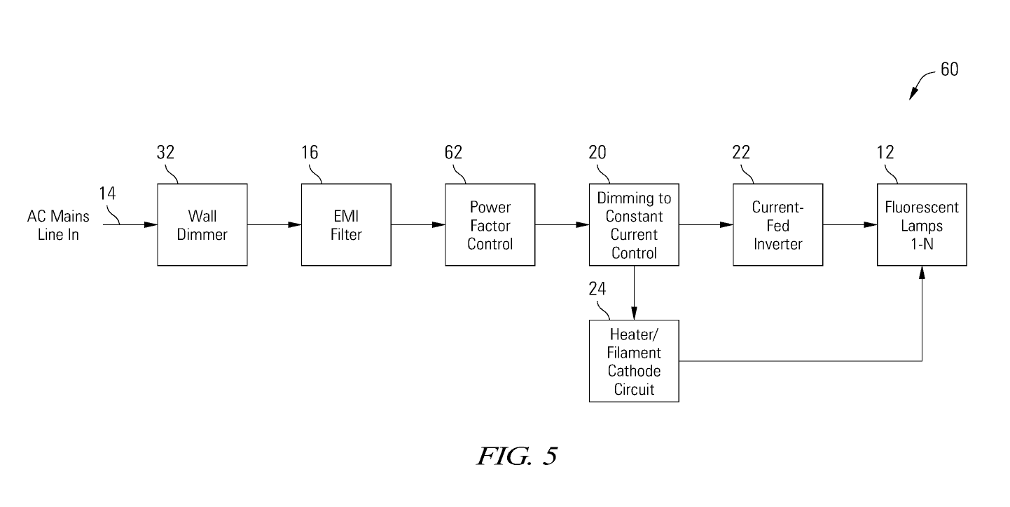

In some embodiments as illustrated in FIG. 2, a fluorescent lamp dimmer 30 may include a wall dimmer 32 connected to the AC mains 14 to controllably adjust the input voltage. The wall dimmer 32 may comprise a TRIAC, transistor, Variac, SCR, or other types of dimmers as discussed above. In some embodiments of a fluorescent lamp dimmer 40 (see FIG. 3), the dimming to constant current control circuit 20 may be replaced with a power factor control and dimming to constant current control circuit 42. A power factor control circuit 44 may also be connected to the heater/filament cathode circuit 24 to maximize the power factor for the heaters. In yet other embodiments of a fluorescent lamp dimmer 50 (see FIG. 4), power factor control may be integrated in the heater/filament cathode circuit 52. In other embodiments of a fluorescent lamp dimmer 60 (see FIG. 5), a power factor control circuit 62 may be provided at the input to both the dimming to constant current control circuit 20 and heater/filament cathode circuit 24 to maximize power factor for the entire fluorescent lamp dimmer 60. In other embodiments, the power factor correction can be designed, incorporated, implemented, embedded, etc. within or as an integral part of the circuit, etc.

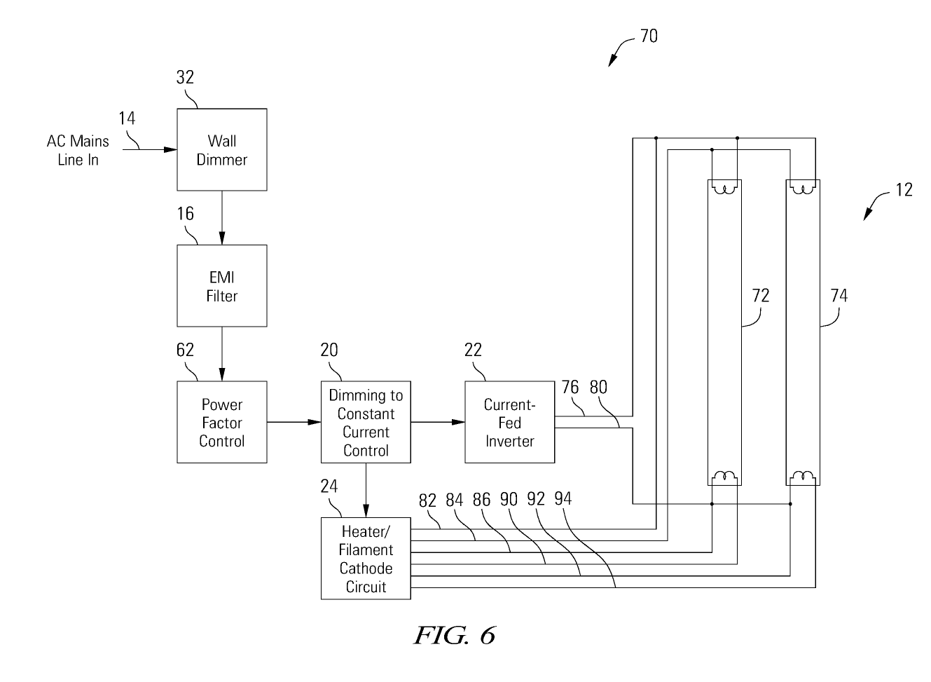

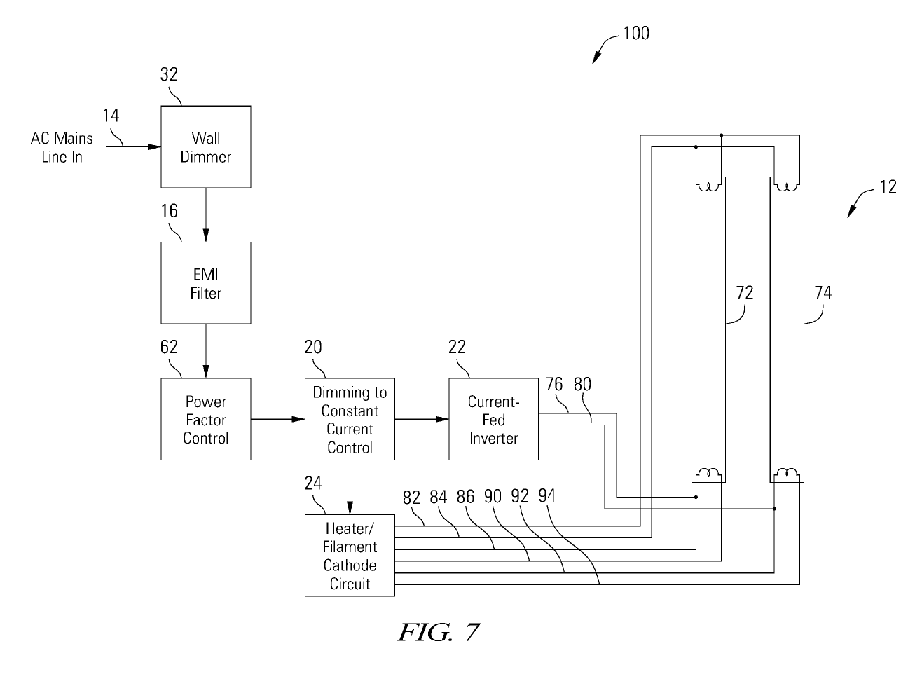

Turning now to FIGS. 6 and 7, the connections from the fluorescent lamp dimmers 70 and 100 to two fluorescent lamps 12 are illustrated, with parallel and serial connections, respectively. In FIG. 6, the current fed inverter 22 has two outputs 76 and 80 that are connected to one heater terminal at each end of each lamp 72 and 74. The heater/filament cathode circuit 24 has two common outputs 82 and 84 that are each connected to a heater terminal on both lamps 72 and 74, and two isolated outputs 86 and 90, 92 and 94, with outputs 86 and 90 connected across the heater terminals at one end of lamp 72 and with outputs 92 and 94 connected across the heater terminals at one end of lamp 74. In this embodiment, the heater voltage is the same for the heaters at one end of the lamps 72 and 74, and can be independently controlled at the other ends of the lamps 72 and 74 as desired. This is merely an example and illustration of some of the ways in which the heater connections may be adapted in various embodiments, and the fluorescent lamp dimmer 70 is not limited to these particular heater connections.

In FIG. 7, the heater connections to the heater/filament cathode circuit 24 remain as in FIG. 6, but the lamps 72 and 74 are connected in series across the current fed inverter 22. In this embodiment, the outputs 76 and 80 of the current fed inverter 22 are each connected to one heater terminal at distal ends of the series combination of lamps 72 and 74, with a heater connection 82 and/or 84 completing the series connection between the lamps 72 and 74.

In this configuration, the current through the two lamps is the same as the lamps are in series. Note that although two fluorescent lamps are shown in FIGS. 6 and 7, the present invention is not limited to two fluorescent lamps; any number of fluorescent lamps, from 1 to N (where N typically is 2, 3 or 4 or higher) can be used with the present invention. As stated in the previous sentence, a single fluorescent lamp of any type to numerous fluorescent lamps of any type can be powered and driven by the present invention.

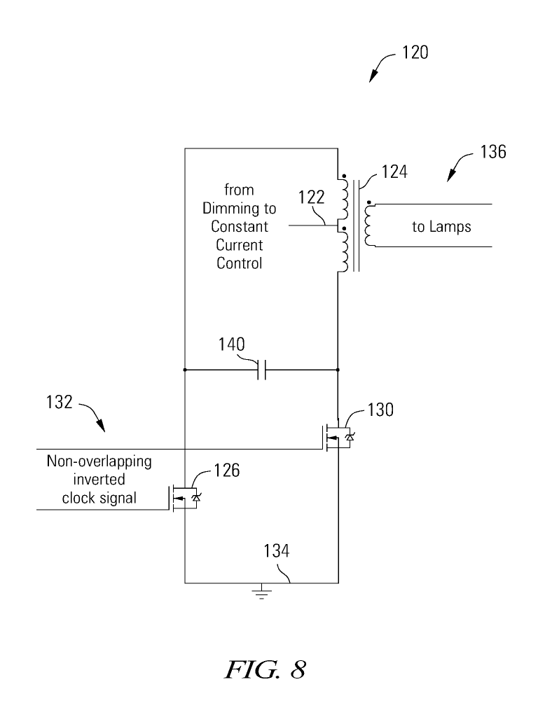

Turning now to FIG. 8, an example embodiment of a current fed inverter 120 is illustrated that may be used as a current fed inverter 22 in the embodiments of FIGS. 1-7. However, the current fed inverter 22 is not limited to the embodiment of FIG. 8. The current fed inverter 120 receives as input the constant current signal 122 from the dimming to constant current control circuit 20. The constant current signal 122 is connected to, for example, the center tap on the primary winding of a transformer 124. The current through the two sections of the primary winding is alternately switched by, for example, transistors 126 and 130, under the control of a non-overlapping inverted clock signal 132, such as a PWM signal and its complement, suitably processed to prevent overlapping of the signal and its complement. For example, the non-overlapping inverted clock signal 132 may operate at a relatively high frequency, for example in the thousands or tens of thousands of kilohertz, in order, for example, to increase the efficiency of the fluorescent lamps.

Transistors 126 and 130 are not limited to the illustrated field effect transistors (FET), but may comprise any suitable type of transistor or other switching device, such as a bipolar transistor or field effect transistor of any type and material including but not limited to metal oxide semiconductor FET (MOSFET), junction FET (JFET), insulated gate bipolar transistor (IGBT), enhancement or depletion mode transistors, etc, and can be made of any suitable material including ones made of silicon, gallium arsenide, gallium nitride, silicon carbide, silicon on insulator, etc. which has a suitably high voltage rating. The transistors or switches 126 and 130 thus alternately allow current from the constant current signal 122 to flow through each section of the primary winding of the transformer 124 to ground 134, producing an alternating current in the secondary winding of the transformer 124 to the outputs 136 for the fluorescent lamps 12. One or more capacitors 140 may be connected across the primary winding of the transformer 124 to condition the signals as desired and to support resonant operation.

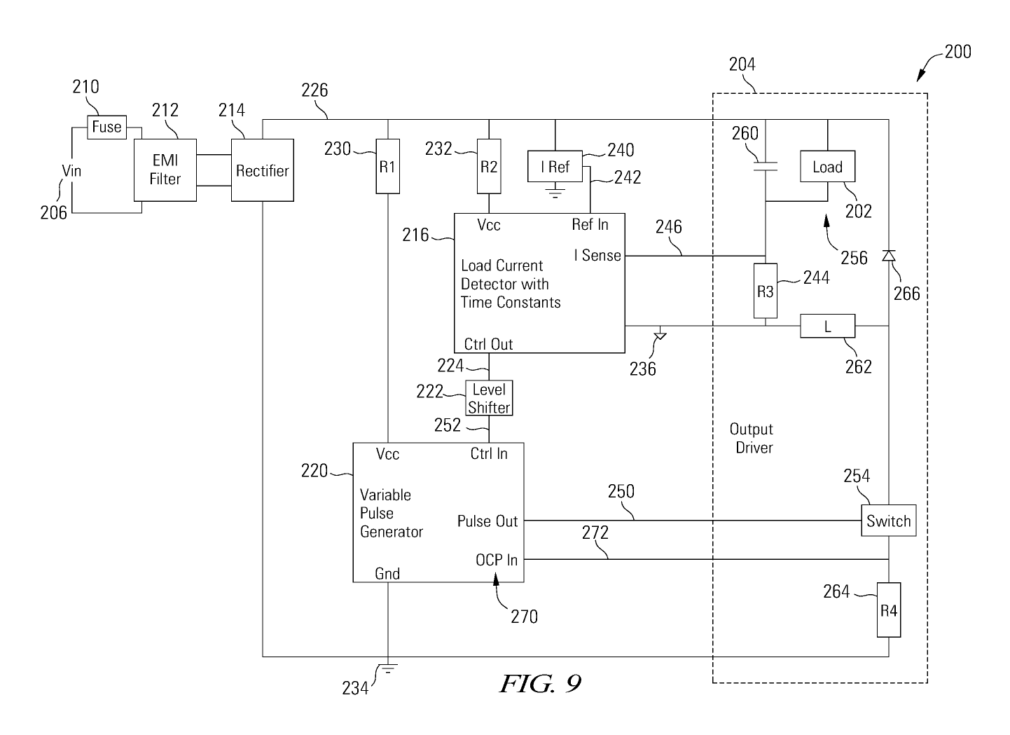

Turning to FIG. 9, an example circuit 200 is illustrated that may be used in place of one or both the dimming to constant current control circuit 20 and heater/filament cathode circuit 24. In the diagram of FIG. 9, the load 202 is shown inside the output driver 204 for convenience in setting forth the connections in the diagram. An AC input 206 is shown, and is connected to the circuit 200 in this embodiment through a fuse 210 and an electromagnetic interference (EMI) filter 212. The fuse 210 may be any device suitable to protect the circuit 200 from overvoltage or overcurrent conditions, such as a traditional meltable fuse or other device (e.g., a small low power surface mount resistor), a circuit breaker including a solid state circuit breaker, etc. The EMI filter 212 may be any device suitable to prevent EMI from passing into or out of the circuit 200, such as a coil, inductor, capacitor and/or other components and/or any combination of these, or, also in general, a filter, etc. The AC input 206 is rectified in a rectifier 214 as discussed above. In other embodiments, the circuit 200 may use a DC input. In this embodiment, the circuit 200 may generally be divided into a high side portion including a load current detector 216 and a low side portion including a variable pulse generator 220, with the output driver 204 spanning or including the high and low side. In this case, a level shifter 222 may be employed between the load current detector 216 in the high side and the variable pulse generator 220 in the low side to communicate the control signal 224 to the variable pulse generator 220. The variable pulse generator 220 and load current detector 216 are both powered by the power output 226 of the rectifier 214, for example through resistors 230 and 232, respectively. The high side, including the load current detector 216, floats at a high potential under the voltage of the input voltage 206 and above the circuit ground 234. A local ground 236 is thus established and used as a reference voltage by the load current detector 216.

A reference current source 240 supplies a reference current signal 242 to the load current detector 216, and a current sensor such as a resistor 244 provides a load current signal 246 to the load current detector 216. The reference current source 240 may use the circuit ground 234 as illustrated in FIG. 9, or the local ground 236, or both, or some other reference voltage level as desired. The load current detector 216 compares the reference current signal 242 with the load current signal 246, optionally using one or more time constants to effectively average out and disregard current fluctuations due to any waveform at the input voltage 206 and pulses from the variable pulse generator 220, and generates the control signal 224 to the variable pulse generator 220. The variable pulse generator 220 adjusts the pulse width of a train of pulses at the pulse output 250 of the variable pulse generator 220 based on the level shifted control signal 252 from the load current detector 216, which is activated when the current through the load 202 has reached a maximum level. When the voltage level at AC input 206 changes, for example when dimmed by an external triac dimmer, the reference current signal 242 will change in response, varying the current through the load 202. In other embodiments, the reference current source 240 may be adjusted by an internal dimmer to vary the current through the load 202.

The level shifter 222 shifts the control signal 224 from the load current detector 216 which is referenced to the local ground 236 in the load current detector 216 to a level shifted control signal 252 that is referenced to the circuit ground 234 for use in the variable pulse generator 220. The level shifter 222 may comprise any suitable device for shifting the voltage of the control signal 224, such as an opto-isolator or opto-coupler, resistor, transformer, transistors, etc. The use of an isolated level shifter such as a optocoupler or optoisolator or transformer may be desired, required and/or beneficial for certain applications.

The pulse output 250 from the variable pulse generator 220 drives a switch 254 such as a field effect transistor (FET) in the output driver 204. When a pulse from the variable pulse generator 220 is active, the switch 254 is turned on, drawing current from the input voltage 206, through the load path 256 (and an optional capacitor 260 connected in parallel with the load 202), through the load current sense resistor 244, an inductor 262 in the output driver 204, the switch 254, and a current sense resistor 264 to the circuit ground 234. When the pulse from the variable pulse generator 220 is off, the switch 254 is turned off, blocking the current from the input voltage 206 to the circuit ground 234. The inductor 262 resists the current change and recirculates current through a diode 266 in the output driver 204, through the load path 256 and load current sense resistor 244 and back to the inductor 262. The load path 256 is thus supplied with current alternately through the switch 254 when the pulse from the variable pulse generator 220 is on and with current driven by the inductor 262 when the pulse is off. The pulses from the variable pulse generator 220 have a relatively much higher frequency than variations in the input voltage 206, such as for example 30 kHz or 100 kHz as compared to the 100 Hz or 120 Hz that may appear on the input voltage 226 from the rectified AC input 206.

In the embodiment of FIG. 9, current overload protection 270 is included in the variable pulse generator 220 and is based on a current measurement signal 272 by the current sense resistor 264 connected in series with the switch 254. If the current through the switch 254 and the current sense resistor 264 exceeds a threshold value set in the current overload protection 270, the pulse width at the pulse output 250 of the variable pulse generator 220 will be reduced or eliminated. The example circuit 200 of FIG. 9 is shown implemented in the discontinuous mode; however with appropriate modifications operation under continuous or critical conduction or resonant modes and other modes can also be realized.

The operation of the circuit 200 as a dimming to constant current control circuit 20 is graphically illustrated in the current plot of FIG. 10. Input voltage is plotted on the X-axis, output current is plotted on the Y-axis, and the plotted line 300 represents the load current. In the example of FIG. 10, the circuit 200 is adapted to limit the load current at about 0.243 A, and the variable pulse generator 220 is set at an input voltage range of about 0 VAC-120 VAC based on the needs of the fluorescent tube in the example load. As the input voltage increases, the output current increases until the input voltage reaches about 120 VAC, at which point the load current level hits a shoulder 302 and is limited.

The shoulder 302 may be shifted, for example, by scaling the reference current signal 242. The operation of the circuit 200 as a heater/filament cathode circuit 24 is graphically illustrated in the current plot of FIG. 11, in which the shoulder 304 is shifted to about 35V, producing a constant voltage or current 302 at very small dimming angles to keep the heater circuits in fluorescent tubes powered when the fluorescent lamp dimmer 10 is dimmed. Notably, the voltage and current levels shown in FIGS. 10 and 11 are merely examples and should not be viewed as limiting in any way. For example, an isolated version using, for example, a fly-back transformer version of the circuit discussed above, can be used as well as other types of fly-back and other isolated circuits, topologies, and approaches. Again, nothing in the example embodiments shown and/or discussed should be viewed as limiting in any way or form.

The present invention may also include anti-striation circuitry including circuitry that operates through the gate (base) or the drain (collector) of the FETs (BJTs) or other similar electrodes and principles for other types of devices (e.g., IGBTs). Other embodiments may use other forms, methods, types of anti-striation circuitry for the present invention.

In certain implementations, the present invention can be configured as a universal input dimming ballast able to operate over large ranges of AC (or DC) input voltages; for example, 100 to 305 VAC, 100 to 400 VDC, etc. In certain implementations, the present invention can use microprocessors, microcontrollers, field programmable gate arrays (FPGAs), complex logic devices (CLDs), application specific integrated circuits (ASICs), analog and digital logic, etc. to realize some, certain, many, etc. of the features, attributes, functions, operations, performance, etc. for the present invention.

While illustrative embodiments have been described in detail herein, it is to be understood that the concepts disclosed herein may be otherwise variously embodied and employed.

What is claimed is:

1. A dimmable fluorescent lamp apparatus comprising:
a fluorescent lamp power output;
at least one fluorescent lamp heater output;
a dimmable current source operable to yield a controllable constant current;
a current-fed inverter operable to power the fluorescent lamp output from the controllable constant current; and
a heater circuit operable to power the at least one fluorescent lamp heater output, wherein the heater circuit provides power at a substantially constant level while the controllable constant current is variable.

2. The apparatus of claim 1, wherein the heater circuit provides power at a substantially constant voltage level.

3. The apparatus of claim 1, wherein the fluorescent lamp power output is operable to power a plurality of fluorescent lamps, and wherein the at least one fluorescent lamp heater output comprises a heater output for each of the plurality of fluorescent lamps.

4. The apparatus of claim 1, wherein the dimmable current source comprises a variable pulse generator and a load current detector.

5. The apparatus of claim 4, wherein the variable pulse generator comprises a control input and a pulse output, the control input being connected to a control input of the power limiting switch, the pulse output being connected to a control input of the power limiting switch, wherein the variable pulse generator is adapted to effectively vary a duty cycle at the pulse output, and wherein the load current detector comprises an input and an output, the input being connected to the output driver load path and the output being connected to the variable pulse generator control input, wherein the variable pulse generator and the load current detector are adapted to limit the duty cycle when a load current reaches a maximum current limit to substantially prevent the load current from exceeding the maximum current limit.

6. The apparatus of claim 1, wherein the heater circuit comprises a variable pulse generator and a load current detector.

7. The apparatus of claim 1, wherein the dimmable current source is operable to be dimmed by an external dimmer.

8. The apparatus of claim 7, wherein the dimmable current source is powered from an alternating current input, and wherein the dimmable current source is operable to set the controllable constant current at a level proportional to the alternating current input.

9. The apparatus of claim 1, wherein the dimmable current source is operable to be dimmed by an internal dimmer, wherein a level of the controllable constant current is set by the internal dimmer.

10. The apparatus of claim 1, wherein the current-fed inverter is operable to provide an alternating current signal to the fluorescent lamp power output, with a magnitude of the alternating current controlled by the controllable constant current.

11. The apparatus of claim 10, wherein the current-fed inverter comprises a transformer having a center tap, a first input and a second input, with the center tap connected to the controllable constant current from the dimmable current source.

12. The apparatus of claim 11, wherein the first input is switched by a first switch and the second input is switched by a second switch, and wherein the first switch and the second switch are controlled by a non-overlapping signal.

13. The apparatus of claim 1, further comprising a power factor control circuit.

14. The apparatus of claim 1, further comprising an electromagnetic interference filter.

15. The apparatus of claim 1, wherein the dimmable current source is operable to set the controllable constant current at a level appropriate for a plurality of fluorescent lamps connected to the fluorescent lamp output in series.

16. The apparatus of claim 1, wherein the dimmable current source is operable to set the controllable constant current at a level appropriate for a plurality of fluorescent lamps connected to the fluorescent lamp output in parallel.

17. A method of powering a fluorescent lamp system comprising:
generating a controllable constant current to power at least one fluorescent lamp in the fluorescent lamp system; and
generating a constant heater power output to drive at least one fluorescent lamp heater in the fluorescent lamp system, wherein the constant heater power output is operable to yield power at a substantially constant level and wherein the controllable constant current may be varied to dim the fluorescent lamp system.

18. The method of claim 17, wherein the controllable constant current is dimmable by an external dimmer.

19. The method of claim 17, wherein the controllable constant current is dimmable by an internal dimmer.

20. The method of claim 17, wherein the constant heater power output is operable to yield power at a substantially constant voltage level.
